(19) United States
(12) Patent Application Publication
(10) Pub. No.: US 2011/0123294 A1
(43) Pub. Date: May 26, 2011

(54) STUD AND FASTENER WITH STUD AND FLEXIBLE CLIP

(75) Inventors: Christian KEMPF, Wuerzburg (DE); Thomas EHRHARDT, Kaiserslautern (DE)

(73) Assignee: NEWFREY LLC, Newark, DE (US)

(21) Appl. No.: 12/950,395

(22) Filed: Nov. 19, 2010

(30) Foreign Application Priority Data
Nov. 20, 2009 (DE) 20 2009 015 837.3

(51) Int. Cl. F16B 19/00

(52) U.S. Cl. 411/508

(57) ABSTRACT

A fastener assembly for joining a component to a support part, comprises a stud fixable to the support part and a resilient clip fixed to the component and connectable to the stud in a defined position by the head of the stud. The stud further comprises: a shank, a head located at the first end of the shank, and an attachment end formed at the second end of the shank. The head includes an underside with a shoulder having a conically tapering contact surface, and the contact surface of the shoulder has an area with a friction-enhancing surface. The clip further comprises: a fastening section defining an opening to receive the head end of the stud, and resilient retaining means, located in the opening, and engageable with the conically tapered contact surface of the head when the clip is installed on the stud.

### CROSS-REFERENCE TO RELATED APPLICATIONS

This application claims priority from German Patent Application No. 20 2009 015 837.3, filed on Nov. 20, 2009, the disclosure of which is incorporated herein by reference.

### BACKGROUND OF THE INVENTION

The invention concerns a stud for joining a component to a resilient clip, wherein the stud has a shank, a head located at one end of the shank, and an attachment end formed at the other end of the shank, and wherein the head has a greater diameter than the shank and has, on the underside facing the shank, a shoulder with a contact surface conically tapering toward the shank for holding the clip. The invention additionally concerns a fastener with a stud and with a resilient clip that is located on the stud and is held in position by the head of the stud.

Studs and fasteners of the specified type are used primarily in automotive manufacture for fastening attached parts and trim parts to the vehicle body or to body parts such as doors and the like. Fastening here should be accomplished as easily as possible and without the aid of tools.

In order to fasten a trim strip to the body of a motor vehicle, a stud and fastener of the specified type are known from EP 0,489,505 B1. Here, a resilient clip is interlocked with a stud that is welded to the body panel and has a projecting head, wherein the underside of the head has a stepped, conical shoulder that tapers step by step to the diameter of the stud. The clip has a retaining bore whose inside diameter increases correspondingly in steps from an inside diameter equal to the stud diameter, by which means the clip engages the conical shoulder when it is placed on the stud. The steps on the shoulder and on the clip here have flat contact surfaces perpendicular to the axis of the stud, so that the clip can no longer be removed from the stud after placement without being destroyed in the process. Removal of the clip is only possible if the retaining bore can be enlarged perpendicular to the stud axis with a tool.

### BRIEF SUMMARY OF THE INVENTION

The object of the invention is to design a stud of the initially mentioned type such that a resilient clip placed on the stud can be held in place with a relatively high force opposing pull-off from the stud, and that a nondestructive removal is possible by pulling the clip from the stud with a force exceeding the relatively high retention force.

The stated object is achieved according to the invention with respect to the stud by the features specified in claim 1, and with respect to the fastener by the features specified in claim 8. Advantageous embodiments of the stud are specified in claims 2 through 7, and advantageous embodiments of the fastener are specified in claims 9 through 14.

According to the invention, the stud has a shank, a head located at one end of the shank, and an attachment end formed at the other end of the shank, wherein the head has a greater diameter than the shank and has, on the underside facing the shank, a shoulder with a contact surface conically tapering toward the shank for holding a resilient clip, wherein the contact surface has an area with a friction-enhancing surface.

To the great surprise of those skilled in the art, it has been shown that a friction-enhancing surface can considerably increase the retention force opposing pull-off of the clip while nevertheless permitting pull-off of the clip for removal with a force that overcomes the maximum retention force, without destroying the resilient clip in the process, so that the clip can be reused. Experiments with the goal of achieving the same effect through a larger cone angle of the contact surface, in contrast, have not produced a satisfactory result. If the cone angle is chosen large enough that the desired high retention force can be achieved, then sliding off by the clip's retaining means is made sufficiently difficult that the clip can be damaged or destroyed during removal.

The increased friction of the area of the contact surface on the stud can be achieved in various ways. A preferred solution consists in providing the area of increased friction with a rough surface, wherein the arithmetic mean roughness value Rₐ of the surface lies in a range from 3 to 10 μm, in particular in a range from 3 to 6 μm. Alternatively, or in addition, provision can be made for the contact surface to have at least one circumferential groove, in particular however multiple circumferential grooves, wherein each groove preferably has a depth of 200 to 400 μm. The groove or grooves should extend in the circumferential direction and preferably are arranged concentric to the shank. The profile of the groove or grooves can have the shape of a rounded, concave flute or a sawtooth.

The roughening of the surface and the production of the grooves can be accomplished during primary molding of the stud, preferably from metal, by an appropriate design of the sections of the mold that form the contact surface. However, different, subsequent processing steps may also be provided in which the desired roughness or grooved shape of the surface is produced through stamping, knurling, sandblasting, or the like.

The contact surface of the shoulder with rough surface or grooves to increase friction has proven to be especially suitable when the conically tapered contact surface has a cone angle of 100° to 120°, in particular 110°.

A fastener according to the invention includes an inventive stud and a resilient clip that is located on the stud and is held in a defined position by the head of the stud, wherein the clip has a fastening section with an opening to receive the head end of the stud, and the fastening section has, in the opening, resilient retaining means which engage with the conically tapered contact surface of the head—that has an area with a friction-enhancing surface—when the clip is placed on the stud.

The fastener according to the invention permits relatively high retention forces that oppose pull-off of the clip from the stud with low installation forces. In addition, it is possible to pull the clip off of the stud with a tensile force exceeding the maximum retention force without damaging the clip, in order to permit removal of the clip, and thus of the component attached by means of the clip, in this way.

According to a further proposal of the invention, arranged in the opening of the clip's fastening section is at least one resilient locking finger, which extends in the insertion direction from the insertion end of the opening and towards the center of the opening, and which has at its free end a support surface designed to brace against the shoulder, which support surface engages with the contact surface of the stud. Preferably the support surface of the locking finger takes the form of a section of a hollow conical surface that is matched to the contact surface of the shoulder such that it fits closely against the contact surface when the clip is placed on the stud.

As a result of the close fit of the locking finger's smooth support surface against the rough and/or grooved contact surface of the shoulder, a frictional behavior between the two surfaces is achieved that can be well bounded, and a defined use of the sliding of the locking finger from the shoulder is attained.

Preferably the locking finger is attached to the wall of the clip's opening by a flexible section. Thus, the locking finger can be formed as a single piece with the clip. Moreover, provision is made according to the invention for the center axis of the locking finger to be located at an angle of less than 45°, in particular less than 35°, with respect to the axis of the stud when the clip is placed on the stud. This angular position of the locking finger ensures that the locking finger slides off of the shoulder of the stud after the maximum retention force has been overcome.

The invention also provides that the wall of the opening is formed of cylindrical wall sections and, located therebetween, wall sections with a fluted profile, wherein the fluted wall sections extend into the opening with their convex sides and form a guide for the head of the stud, and wherein one locking finger is located on each of the cylindrical wall sections.

The stud is preferably made of metal and is provided with an attachment end designed for welding. The clip is preferably made of plastic.

### BRIEF DESCRIPTION OF THE SEVERAL VIEWS OF THE DRAWINGS

The invention is explained in detail below with reference to exemplary embodiments that are shown in the drawings. They show:

FIG. 1 a first embodiment of a stud according to the invention,

FIG. 2 a second embodiment of a stud according to the invention,

FIG. 3 a perspective view of a clip of a fastener according to the invention with a component to be fastened by the clip, and

FIG. 4 a cross-section of a fastener according to the invention with components joined thereby.

### DETAILED DESCRIPTION OF THE PREFERRED EMBODIMENTS

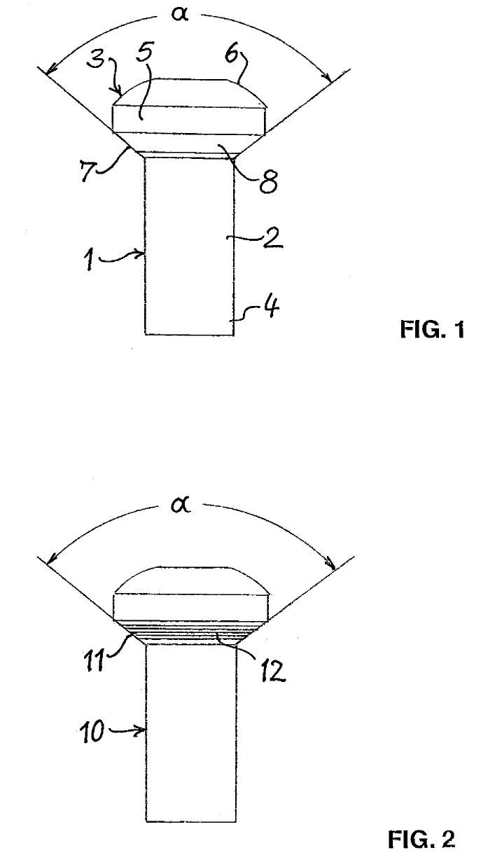

The stud 1 shown in FIG. 1 has a cylindrical shank 2 and a head 3, which is located at one end of the shank 2 and has a larger diameter than the shank 2. The end 4 of the shank 2 opposite the head 3 is intended for fastening the stud 1 to a metal sheet by welding. The head 3 has a center cylindrical section 5, adjoined on the top opposite the shank 2 by a domed cap 6, which facilitates the pushing on of a clip. The underside of the head 3 opposite the cap 6 forms a shoulder 7 in the shape of a truncated cone that tapers towards the shank 2. The circumferential surface of the truncated conical shoulder 7 serves as a contact surface 8 for the resilient retaining means of a clip to be held by the stud 1. The cone angle α of the truncated cone, which is the angle formed by two diametrically opposed generating lines, is 110° in the exemplary embodiment shown. Depending on requirements, somewhat larger or smaller cone angles can also be chosen. However, removal of the clip becomes more difficult as the cone angle increases, and a limit is very soon reached beyond which the clip can no longer be removed without damage. Smaller cone angles facilitate removal, but result in smaller retention force.

In order to increase the retention force opposing pull-off of a clip while simultaneously making removal possible, according to the invention the contact surface 8 of the stud 1 is provided with a rough, friction-enhancing surface. Here, a roughness of the surface has proven advantageous whose arithmetic mean roughness value Rₐ lies in a range from 3 to 10 μm, in particular in a range from 3 to 6 μm. It has been shown that the required retention force can be more easily achieved and is more reliably reproducible with the aid of the rough contact surface 8. This significantly decreases dependence on the size of the cone angle of the contact surface.

FIG. 2 shows an embodiment of a stud 10 that differs from the stud 1 only in the surface design of the contact surface 11 in the shape of a truncated cone. In order to increase friction, the contact surface 11 is provided with multiple, evenly spaced, concentric grooves 12. The grooves can be 200 to 400 μm deep. The groove profile may be rounded in the manner of a flute or sawtooth-like. Other groove profiles are also possible. Preferably, the grooves are located closely enough together that they are only separated from one another by very narrow strips of the conical contact surface 11, or even mutually form only sharp edges that lie on a lateral surface of a cone corresponding to the contact surface 11. The grooves 12 achieve the same effect as the rough surface of the contact surface 8 of the stud 1. The grooves 12 additionally have the advantage that their friction-enhancing effect is less strongly influenced by dirt, moisture, and the like.

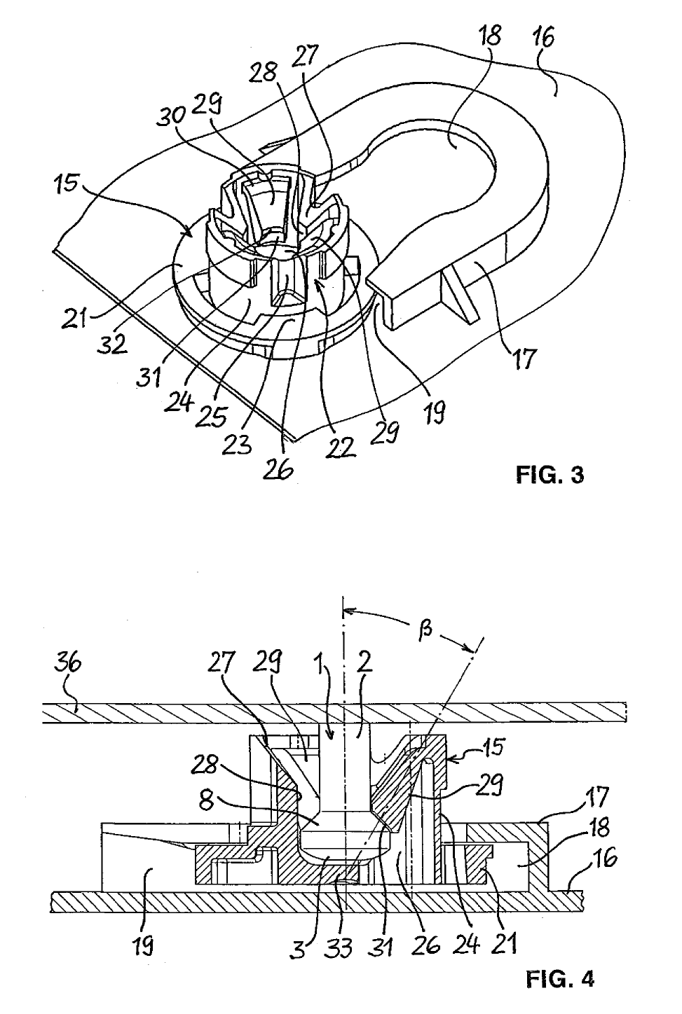

FIG. 3 shows a clip 15 that is intended to fasten a component 16 to a stud 1 or 10. Arranged on the component 16 is a front structure 17 which forms an undercut pocket 18 with a lateral insertion opening 19 by means of which the clip 15 can be placed in the pocket 18.

The clip 15 has an annular flange 21 and a fastening section 22 designed as a hollow part. The flange 21 surrounds one end of the fastening section 22 and is connected thereto by radial webs 23. The thickness and diameter of the flange 21 are dimensioned such that the flange 21 can be inserted in the pocket 18 and held in place therein. The fastening section 22 has a cylindrical wall 24, which is interrupted at three equidistant locations by fluted wall sections 25. The fluted wall sections 25 extend parallel to the center axis of the cylindrical wall 24 and the convex sides of their fluted profiles extend into the fastening section 22. The wall 24 and the wall sections 25 surround a central opening 26, which is intended to receive a stud. In the opening 26, the wall sections 25 form lead-in bevels 27 and axially parallel guide surfaces 28 for centering and guiding the head of a stud.

Also on the inside of the fastening section 22, resilient locking fingers 29 are mounted on the sections of the cylindrical wall 24; each of these fingers extends from the wall 24 in the direction of insertion and towards the center of the opening 26. The locking fingers 29 are connected to the associated section of the wall 24 in the vicinity of the insertion end of the opening 26 by an elastically resilient section 30. In the region of the attachment points of the locking fingers 29, the wall 24 is provided with raised reinforcements on the outside of the wall that increase the wall thickness. The free ends of the locking fingers 29 are located a distance from the flange-side end of the fastening section 22, and have support surfaces 31 to brace against the head and support surfaces 32 to brace against the shank of a stud.

As is evident from FIG. 4, also located in the center of the opening 26 is a rigid stop 33, which is attached to the wall sections 25 and limits the insertion depth of a stud.

FIG. 4 shows the fastening of the component 16 to a support part 36 with the aid of the clip 15. For this purpose a stud 1, which can be connected to the clip 15, is welded to the support part 36. The fastening takes place in that first the clip 15 is inserted in the pocket 18 of the component 16. Then the component 16, with the clip 15 leading, is brought to the support part 36 such that the stud 1 can enter the opening 26 of the clip 15. As a result of pressing the component 16 against the support part 36, the stud 1 with its head 3 leading enters the central opening 26 until it contacts the stop 33. During this process, the head 3 of the stud 1 is centered in the clip 15 by the lead-in bevels 27 and the guide surfaces 28. The locking fingers 29 are initially spread apart upon entry of the head 3 and then spring back into the position shown in FIG. 4 when the head 3 reaches the stop 33. In this location, the locking fingers 29 are braced against the contact surface 8 of the head 3 by their support surfaces 31, and against the shank 2 by their support surfaces 32. In this position, the locking fingers 29 are set at such an angle that their center axes intersect the axis of the stud at an angle β of approximately 30°. The support surfaces 31 of the locking fingers 29 have essentially the same curvature and the same inclination as the contact surface 8 of the stud 1 so that they fit closely against the latter, and a friction between the support surface 31 and the contact surface 8 is provided that is defined by the roughness of the contact surface 8.

As a result of the angle of incidence of the locking fingers 29, the cone angle α of the contact surface 8, and the friction impeding the sliding of the support surface 31 on the contact surface 8 due to the roughness of the contact surface 8, the clip 15 is secured on the stud 1 against pull-off until a predefined maximum pull-off force is reached. If this pull-off force is overcome, the slippage resistance between the support surfaces 31 of the locking fingers 29 and the contact surface 8 is no longer sufficient to hold the locking fingers 29 in position. The locking fingers 29 then slide radially outward from the contact surface 8 so that the stud 1 can be pulled out of the opening 26. In this way, release of the fastening is possible without the aid of a tool and without damaging the clip 15.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A weld stud for holding a clip, the stud comprising
a shank,
a head located at a first end of the shank,
an attachment end formed at a second end of the shank, and
wherein the head has a diameter greater than the shank and has, on the underside facing the shank, the underside including a shoulder with a conically tapering contact surface tapering toward the shank for holding the clip, characterized in that the contact surface of the shoulder has an area with a friction-enhancing surface.

2. A stud according to claim 1, wherein the friction enhancing surface includes a rough surface whose arithmetic mean roughness value Rₐ lies in a range from 3 to 10 μm.

3. A stud according to one claim 1, wherein the conically tapered contact surface defines a cone angle of 100° to 120.

4. A stud according to claim 1, wherein the contact surface includes at least one circumferential groove, and the at least one groove has a depth of 200 to 400 μm.

5. A stud according to claim 4, wherein the at least one groove is arranged concentric to the shank.

6. A stud according to one of claim 4, wherein the groove includes one of a rounded, a concave flute, and a saw tooth profile.

7. A stud according to claim 1, wherein the stud is made of metal and the attachment end is adapted to be welded.

8. A stud according to claim 1, wherein the friction enhancing surface includes a rough surface whose arithmetic mean roughness value Rₐ lies in a range from 3 to 6 μm.

9. A stud according to one claim 1, wherein the conically tapered contact surface defines a cone angle of 110°.

10. A fastener assembly for joining a component to a support part, the fastener assembly comprising:
a stud fixable to the support part, the stud further comprising:
a shank including a first end and a second end,
a head located at the first end of the shank,
an attachment end formed at the second end of the shank,
wherein the head has a greater diameter than the shank and includes an underside facing the shank, the underside including a shoulder with a conically tapering contact surface tapering toward the shank, and the contact surface of the shoulder has an area with a friction-enhancing surface; and
a resilient clip fixed to the component and connectable to the stud in a defined position by the head of the stud, the clip includes:
a fastening section defining an opening to receive the head end of the stud,
a resilient stud retainer, located in the opening, and engageable with the conically tapered contact surface of the head when the clip is installed on the stud.

11. A fastener assembly according to claim 10, wherein the stud retainer comprises at least one resilient locking finger located in the opening and extending axially inward from an insertion end of the opening and radially inward towards the center of the opening, the locking finger includes a free end with a support surface operable to brace against the stud head shoulder and engageable with the contact surface of the stud.

12. A fastener assembly according to claim 11, wherein the support surface of the locking finger is shaped as a concave section of a hollow conical surface that is matched to the contact surface of the stud shoulder such that it fits closely against the contact surface when the clip is placed on the stud.

13. A fastener assembly according to claim 11, wherein the locking finger is attached to a wall of the opening by a flexible section.

14. A fastener assembly according to claim 11, wherein, when the clip is installed on the stud, then an axis of the stud and an axis of the locking finger define an acute angle and that angle is less than 45°.

15. A fastener assembly according to claim 11, wherein, when the clip is installed on the stud, then an axis of the stud and an axis of the locking finger define an acute angle and that angle is less than 35°.

16. A fastener assembly according to claim 11, wherein the fastening section of the clip further includes
a cylindrical wall that partly defines the axial opening, the wall includes a plurality of inward projecting wall sections arranged at intervals around the circumference of the wall interior, the inward projecting wall sections extend axially and radially into the opening and include a radially inward end, the inward end further includes a guide surface that acts to guide the clip relative to the stud head during clip installation onto the stud, and;
wherein the at least one locking finger is located on the wall in a circumferential interval between inward projecting wall sections.

17. A fastener assembly according to claim 10, wherein the clip is made of plastic.
